(19) United States
(12) Patent Application Publication
(10) Pub. No.: US 2024/0145106 A1
(43) Pub. Date: May 2, 2024

(54) Method For Estimating A Future Value Of The Axial Power Imbalance In A Nuclear Reactor

(71) Applicants: Electricite de France, Paris (FR); Centre National de la Recherche Scientifique (CNRS), Paris (FR); Ecole Centrale De Nantes, Nantes (FR)

(72) Inventors: Madina Traore, Meudon La Foret (FR); Giorgio Simonini, Versailles (FR); Yannig Goude, Voisins Le Bretonneux (FR); Mathieu Lagrange, Orvault (FR); Alexandre Girard, Rueil-Malmaison (FR); Jérôme Idier, Nantes (FR)

(73) Assignees: Electricite de France, Paris (FR); Centre National de la Recherche Scientifique (CNRS), Paris (FR); Ecole Centrale De Nantes, Nantes (FR)

(21) Appl. No.: 18/385,701

(22) Filed: Oct. 31, 2023

(30) Foreign Application Priority Data
Oct. 31, 2022 (FR) 2211635

(51) Int. Cl. G21C 17/06

(52) U.S. Cl. CPC G21C 17/06

(57) ABSTRACT

Method for estimating an axial power imbalance in a nuclear reactor, comprising the following steps:
obtaining a reactor power setpoint,
for each variable of a plurality of variables of the reactor, determining a sequence of the variable, the sequence representing estimated future variations of the variable,
determining a sequence of the axial power imbalance, by taking into account the sequences of the plurality of variables of the reactor, the determination of the sequence of the axial power imbalance using a machine learning module that is trained beforehand on historic reactor data.

### FIELD OF THE INVENTION

The invention relates to the estimating of a future value of the axial power imbalance in a nuclear reactor.

### PRIOR ART

Nuclear power plants, as “controllable” production means, are one of the main contributors to the balancing of the electricity grid in France. Since electricity cannot (or can barely) be stored, the equality between electrical power produced by the various production means and the electrical power consumed by users must be verified at each instant. However, the consumers and a portion of the production means, in particular so-called renewable electricity production means such as wind turbines and photovoltaics, are not controllable and are intermittent: a controllable production means, such as nuclear power, is therefore required in order to compensate the fluctuations in consumption and in the uncontrollable production, in order to ensure the balance between supply and demand. For this, the nuclear reactors of the nuclear power plants must be technically able to vary the electrical power produced rapidly according to the need, while remaining within the operating and safety ranges which are assigned to them. The operating ranges are determined, in particular, as a function of the axial power imbalance and the Xenon oscillations now described.

Axial Power Imbalance in a Reactor

Within a reactor, the thermal energy which is intended to be transformed into electrical energy is produced by fission. Nuclear fission is a phenomenon by which a heavy atomic nucleus, such as uranium or plutonium, splits into two (binary fission) or three (ternary fission) lighter nuclides, either spontaneously or after having absorbed a neutron. The study of the movement of neutrons in matter and the reactions that they induce is termed neutronics, in particular the generation of power by fission. Neutronics is the basis of the design of controlled fission nuclear reactor cores, such as pressurised water reactors.

With regard to FIG. 1, illustrating a reactor 1, the axial direction z can be defined as the vertical direction given by a plumb line. This direction z is oriented vertically upwards in FIG. 1. It is desired to characterise a difference between a power P h in the upper half of the core of the reactor and a power P b in the lower half of the core of the reactor. Curve 5 shows the power as a function of the height z in the reactor.

This difference varies under the effect of the control rods or clusters, the presence of neutronic poisons such as fission products such as xenon or samarium, and the temperature of the fuel or its depletion rate which increases with time during the operating campaign of the reactor.

The power difference between the top and bottom of the reactor can be characterised by two physical quantities: an axial offset (abbreviated AO) and an axial power imbalance that can be designated by the notations “ΔI” or “DPAX”). These two quantities are defined by the following formulas:

$$AO = \frac{{P}_{h} - {P}_{b}}{{P}_{h} + {P}_{b}}$$

$$DPAX = \frac{{P}_{h} - {P}_{b}}{{P}_{n}}$$

where Pₙ is the nominal power of the reactor.
The term Pₕ+P_{b}=Pₜ designates the instantaneous total power in the reactor. The axial offset is a relative value of power with respect to the total power.

The axial imbalance “DPAX” is a relative value of power with respect to the nominal power Pₙ, which nominal power is not necessarily equal to the instantaneous total power Pₜ.

Xenon Oscillation

Xenon 135 (¹³⁵Xe) is a strong neuron absorbing element which can be produced by fission but also, and above all, by decay of iodine-135 (¹³⁵I), another product of the fission reaction. The presence of xenon-135 within a reactor leads to a significant reduction in reactivity, making it a neutron poison which harms the maintenance of the chain reaction.

After a sufficiently long operating time of the reactor (approximately 60 hours) at constant power of the reactor, the concentration of xenon-135 reaches a first equilibrium in the reactor. This equilibrium is reached when the production of xenon-135 becomes proportional to the power of the reactor and when its destruction becomes proportional to the concentration of iodine-135.

On the macroscopic scale, if the power of the reactor is reduced once this equilibrium is reached, the concentration of iodine-135 decreases exponentially until reaching a new equilibrium value, while the concentration of xenon-135 first passes through a maximum (referred to as the xenon peak) before decreasing until reaching a new equilibrium value. The time necessary to reach this peak (between 7 and 8 hours), as well as the value of antireactivity which corresponds to it, depend on the power of the reactor before and after the reduction. The reactivity ρ is a unitless quantity expressed in pcm (parts per hundred thousand) which is defined as a relative variation of the effective coefficient of multiplication of the neutron population k_{eff}, itself defined as the ratio of the population of neutrons of the present generation and the population of neutrons of the preceding generation:

$$ρ = \frac{{k}_{eff} - 1}{{k}_{eff}}$$

The sign of the reactivity ρ indicates whether the neutron population is stable (ρ=0), increasing (ρ>0), or decreasing (ρ<0).

This is referred to as antireactivity when ρ<0

Conversely, if the power is increased, the concentration of iodine-135 increases until reaching a new equilibrium value while the concentration of xenon-135 first passes through a minimum (referred to as a xenon pit) before increasing until reaching a new equilibrium value. The time necessary to reach this minimum (between 2 and 3 hours), as well as the value of antireactivity which corresponds to it, will depend on the power before and after the increase.

Locally, a variation in power, by insertion of clusters, is manifest by an axial effect on the distribution of the neutron flux and leads to a modification of the distribution of iodine-135 and of xenon-135.

FIG. 1 shows the insertion then withdrawal of a neutron poison rod or cluster 3 extending in the vertical direction z.

The effect of this inserted then withdrawn rod 3 can be broken down into five phases corresponding with the letters A to E in FIG. 1. This manoeuvre impacts, in particular, the concentration of xenon 9 as a function of height z in the reactor, and the concentration of iodine 7 as a function of height z in the reactor.

The insertion then withdrawal of the rod can lead to oscillations in the concentration of xenon 9 between the upper half and the lower half of the reactor, commonly called xenon oscillations.

This oscillation breaks down into five phases corresponding to the letters A to E shown in FIG. 1.

Phase A correspond to a permanent regime, in which the axial power distribution 3 and the concentrations 7 and 9 of iodine-135 and xenon-135 are in phase.

Phase B corresponds to the insertion of a group of clusters 3 into the reaction medium of the reactor 1. This induces a change in the axial power distribution: the power decreases in the upper half but remains approximately constant in the lower half. The balance between the production, by radioactive decay of iodine-135 and the disappearance of xenon-135 by neutron capture or by radioactive decay is interrupted. In the first instants of this type of transients, the distributions of iodine-135 and xenon-135 remain unchanged, while the power in the bottom of the core increases and that at the top decreases.

During phase C, in the top of the core, due to the reduction in neutron flux caused by the insertion of the group of clusters, the concentration 7 of iodine-135 can be seen and decreases, and the xenon-135 disappears more slowly and starts to accumulate: the concentration 9 of xenon-135 increases thus causing a reduction in reactivity. In the bottom of the core, due to the increase in flux, the concentration 7 of iodine-135 increases and the concentration 9 of xenon-135 decreases because the xenon-135 disappears more rapidly. The reactivity increases in the lower half. This redistribution of the reactivity between the top and bottom of the core tends to amplify the phenomenon of imbalance with a maximum axial imbalance reached at the end of 7 to 8 hours, and this even if the inserted group of rods is withdrawn.

Phase D corresponds to the period after the maximum of the axial imbalance has been reached. In the top of the core, the reduction in concentration 7 of iodine-135 causes a deficit in the production of xenon-135, the concentration 9 of which starts to decrease, thus causing an increase in the reactivity. In the bottom of the core, the accumulation of iodine-135 compensates the disappearance of xenon-135, the concentration 9 of which starts to increase, thus causing a reduction in the reactivity. This process continues over time until a spatial distribution of the power is obtained that is close to the initial situation at the end of 17 to 18 hours. At that time, the concentration 7 of iodine-135 and the concentration 9 of xenon-135 are highly imbalanced. The xenon curve in phase D is in an intermediate position between the xenon curve in phase C and the xenon curve in phase E.

In phase E, the phenomenon reverses and the power peak swings towards the top of the core. The period of this oscillation is of order 35 hours.

The neutron flux deformations induced by the movement of the control clusters and/or by the xenon oscillations can be at the origin of the formation of hot points inside the reactor leading to an excessive increase in temperature of the fuel which can lead to it losing its integrity. To prevent this risk, it is compulsory to control the axial power imbalance in order to control the reactors. The operators rely on a control diagram representing the axial imbalance as a function of the instantaneous total power. This diagram illustrates, in particular, a safety zone or operating domain of the reactor which is a zone around a reference straight line. The reactor must operate in the zone close to the reference straight line. In order to control the reactors in a safe and efficient manner, the operators therefore need to have tools capable of predicting the axial power imbalance DPAX as a function of the envisaged control strategy, thus enabling them to evaluate this strategy beforehand and to potentially envisage another strategy which will further limit the axial power imbalance.

Current solutions for estimating the future state of the reactor do not provide satisfactory assistance for the control. In practice, operators are requested to modify power setpoints and monitor the evolution of the main key parameters of the core of the nuclear reactor in order to meet the operating constraints. As stated, the variation in power and the other variations associated with it (variations in the average temperature of the core, movements of the control rods, evolution of the concentration of boric acid in the refrigerant of the reactor, etc.) generate disturbances, the effect of which is difficult to anticipate: the state of the reactor, and therefore its response to stresses, evolves continuously; the phenomena in play are complex and characterised by very heterogeneous characteristic times, from several seconds to several hours, and the evolution of some parameters, such as the concentration and spatial distribution of xenon in the reactor, cannot be measured and therefore cannot be known by the operator.

Hence, in order that the nuclear reactors of nuclear power plants can be technically able to rapidly vary the electrical power produced according to need, and to do this more frequently than former practices, while remaining within the operating and safety ranges assigned to them, there is a need to have a tool for reliable and fast estimation in order to easily predict future delayed effects of each action of the operator, in the context of extended planning.

### DISCLOSURE OF THE INVENTION

An object of the invention is to provide a method for estimating a future value of an axial power imbalance in a nuclear reactor.

The object is achieved in the context of the present invention through a method for estimating a future value of an axial power imbalance of a nuclear reactor, the method comprising the following steps:
obtaining a sequence of successive values of a reactor power setpoint,
for each variable of a plurality of variables of the reactor, determining a sequence of successive values of the variable, the sequence representing future variations of the variable, the variations being estimated by taking into account the power setpoint, the plurality of variables of the reactor comprising a concentration of xenon in an upper half of the reactor and a concentration of xenon in a lower half of the reactor,
determining a sequence of successive values of the axial power imbalance, by taking into account the sequences of the plurality of variables of the reactor, the determination of the sequence of the axial power imbalance using a machine learning module trained beforehand on historic reactor data, and the determination of the sequence of the concentration of xenon in the upper half of the reactor and the determination of the sequence of the concentration of xenon in the lower half of the reactor using a model of the evolution of a concentration of iodine and of a concentration of xenon as a function of a neutron flux

Such a method is advantageously and optionally supplemented by the various following features, taken alone or in combination:
for at least one variable of the plurality of variables, the determination of the time sequence of the variable comprises a measurement of the variable;
the plurality of variables of the reactor comprises at least one of: a position of a device configured to absorb neutrons in the reactor, a measured average temperature of the reactor vessel, a flow rate of a heat-transfer fluid circulating in the reactor, a concentration of a chemical species in the heat-transfer fluid, the chemical species being configured to absorb neutrons in the reactor, and a rate of combustion of a nuclear fuel contained in the reactor;
the determination of the sequence of the axial power imbalance also takes into account at least one of: a reference average temperature of the vessel, a type of fuel management corresponding to a splitting of a reactor core during a renewal of the fuel, an enrichment of fissile nuclei of the reactor and a type of heavy nuclei of the reactor;
the determination of the sequence of the plurality of reactor variables and the determination of the sequence of the axial power imbalance takes into account a control scenario of the reactor corresponding to a sequence of successive values of at least one variable controllable by an operator;
a step of determining a score of the control scenario, the score preferably being a value of a quantity chosen from: a volume of effluent produced, an average difference from the reference axial imbalance and an average distance to the limits of an operating range of the reactor; and
the control scenario is a first control scenario, the steps of the method being carried out a second time by replacing the first scenario by a second control scenario of the reactor corresponding to another sequence of successive values of at least one controllable variable, the method preferably comprising a step of comparing scores of the first scenario and second scenario.

The invention also relates to a computer program comprising instructions suitable for implementing at least one of the steps of the method as presented above, when said program is executed on a computer.

Finally, the invention relates to a device for estimating a future value of an axial power imbalance in a nuclear reactor, the device comprising a computing module configured to implement the method as described above, the computing module being configured to:
obtain a sequence of successive values of a reactor power setpoint,
determine, for each variable of a plurality of variables of the reactor, a sequence of successive values of the variable, the sequence representing future variations of the variable, the variations being estimated by taking into account the power setpoint, the plurality of variables of the reactor comprising a concentration of xenon in an upper half of the reactor and a concentration of xenon in a lower half of the reactor,
determine a sequence of successive values of the axial power imbalance by taking into account the sequence of the plurality of variables of the reactor,
the computing module comprising a machine learning module trained beforehand on historic reactor data, and
the computing module using a model of evolution of a concentration of iodine and of a concentration of xenon as a function of a neutron flux, so as to determine the sequence of the concentration of xenon in the upper half of the reactor and the sequence of the concentration of xenon in the lower half of the reactor.

### DESCRIPTION OF THE FIGURES

Other features and advantages of the invention will emerge from the following description, which is given purely by way of illustration and not being limiting and which should be read with reference to the attached drawings, in which:

FIG. 1, already mentioned, is a schematic illustration relating to a xenon oscillation phenomenon;

FIG. 2 is a schematic illustration relating to an embodiment of a method for estimating an axial power imbalance in a reactor;

FIGS. 3 and 6 schematically illustrate an axial power imbalance as a function of time,

FIGS. 4 and 7 schematically illustrate a power setpoint as a function of time, and

FIGS. 5 and 8 schematically illustrate a power setpoint as a function of an axial power imbalance.

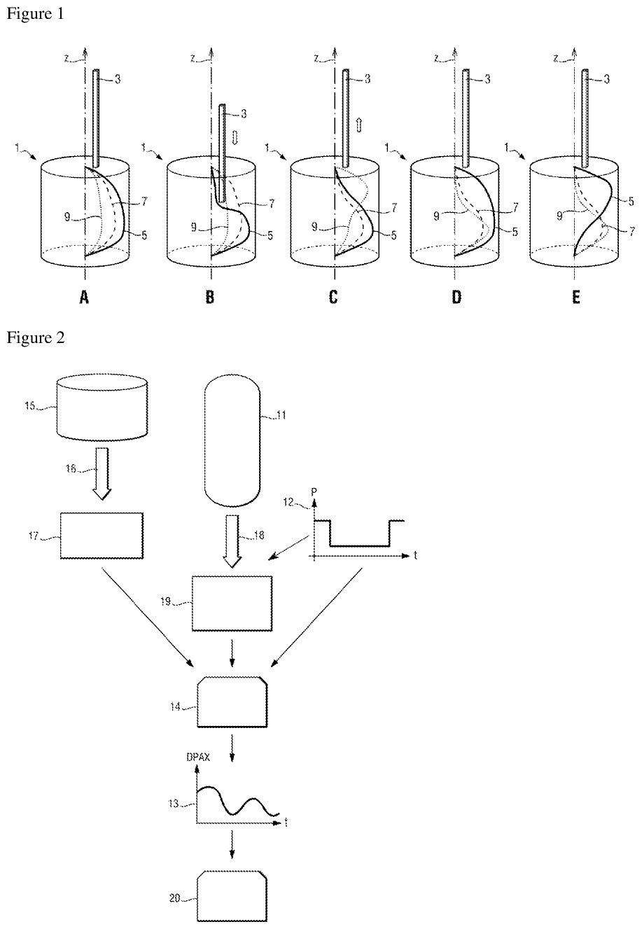

### DETAILED DESCRIPTION OF THE INVENTION

Method for Estimating of a Future Value of an Axial Power Imbalance

A method for estimating a future value of an axial power imbalance in a nuclear reactor 11 is proposed in FIG. 2.

The axial power imbalance in a nuclear reactor has been previously introduced under the notation “DPAX”, it is a relative power value with respect to the nominal power Pₙ of the reactor.

$$D P A X = \frac{{P}_{h} - {P}_{b}}{{P}_{n}}$$

A sequence 12 of successive values of a power setpoint P of the reactor is obtained during a first step. A sequence of successive values taken by a quantity is also designated hereinafter by the expression “time series”.

This step corresponds, in particular, to the situation where an operator who controls a nuclear reactor must produce a power transient 12 of this reactor. The operator enters a load program, in other words an evolution of the electrical power P of the reactor as a function of time t. This evolution can be given, in particular, in the form of a time series of power values to be observed, in other words values of a power setpoint as a function of time. Here, therefore, a power setpoint is therefore understood to mean a physical quantity homogeneous with a power and which is the power to be observed.

In a second step 18 of the method, the load program is processed in order to determine future variations 19 of a plurality of variables of the reactor. These different variables are called explanatory variables in the sense where they are used to estimate the values of another variable which is the axial power imbalance. Hypothetical values which the explanatory variables will take are therefore determined. In other words, for each variable of a plurality of variables of the reactor, a time series of the variable representing future variations of the estimated variable is determined by taking into account the power setpoint. The time series can also comprise past variations of the variable.

The explanatory variables include the concentration of xenon in the upper half of the reactor and the concentration of xenon in the lower half of the reactor. These two variables are calculated with the assistance of an evolution model of a concentration of iodine and of a concentration of xenon as a function of a neutron flux. This model is based, in particular, on the following equations of evolution of the concentration of iodine and of xenon.

$$\frac{d {C}_{I}}{d t} = {γ}_{I} {\sum }_{f} ϕ - {λ}_{I} {C}_{I}$$

$$\frac{d {C}_{Xe}}{d t} = {γ}_{Xe} {\sum }_{f} ϕ + {λ}_{I} {C}_{I} - {λ}_{Xe} {C}_{Xe} - {σ}_{a}^{Xe} {C}_{Xe} ϕ$$

set for each half, upper and lower, of the reactor.

In these equations, ϕ designates the neutron flux, C_{I} designates the concentration of iodine, C_{Xe} designates the concentration of xenon, γ_{I} designates the fission yield of iodine and γ_{Xe} the fission yield of the xenon, respectively. A fission yield of a product corresponds to the probability or rate of production of this product when fission is produced. Σ_{f} designates the effective macroscopic fission cross-section, in other words the macroscopic probability of fission of heavy nuclei related to the probability per unit time that a neutron encounters a heavy nucleus and that a fission is produced. Δ_{I} designates the rate of radioactive decay of iodine and Δ_{Xe} the rate of radioactive decay of xenon. Finally, σ_{Xe}^{α} designates the effective microscopic cross-section for the absorption of neutrons for xenon connected to the probability per unit time that a neutron encounters a xenon-135 nucleus and that it is captured (which does not generate fission).
γ_{I}Σ_{f}ϕ□□ is a term representing the production of iodine-135.
−λ_{I}C_{I} is a term representing the disappearance of iodine-135.
γ_{Xe}Σ_{f}ϕ+λ_{I}C_{I} is a term representing the production of xenon-135.
−λ_{Xe}C_{Xe}−σ_{α}^{Xe}C_{Xe}ϕ a term representing the disappearance of xenon-135.

During a third step of the method, a time series 13 of the axial power imbalance DPAX is determined by taking into account the time series of the plurality of variables of the reactor. The time series represents, as a function of time t, future variations of the axial power imbalance estimated by taking into account the time series of the plurality of variables of the reactor and the load programme.

This determining of the series of the axial power imbalance is carried out using a machine learning module 14, trained beforehand on historic reactor data 15. It should be noted that the learning module can be retrained at the end of an operating cycle of the reactor in order to take into account the learning of more recent operating data. This training of the model on the entire database takes less than 4 hours.

The historic reactor data 15 are structured during an extraction step 16 so as to obtain structured historic operating data 17. In particular, during this extraction step, the data can be enriched with historic values of axial offset AO and/or axial imbalance DPAX. It can be sought, in particular, to determine the axial imbalance DPAX on the basis of the axial offset AO when it is the only available variable, the measurements of the axial offset AO generally being noisier than those of the axial imbalance DPAX, in particular when the instantaneous power of the reactor is low.

The machine learning module 14 is configured to be trained on sets of historic data 15 from one or more reactors. This machine learning module can comprise, in particular, two sub-modules.

The first sub-module is configured to learn a relation between a set of explanatory variables and the axial power imbalance. After having learned this relation from the historic operating data 17 of the reactors, the first sub-module processes values 19 of recent and hypothetical explanatory variables in order to provide a first prediction of the axial power imbalance over the coming hours. Several algorithms can be used to implement this first sub-module.

A first option uses forests of decision trees, such as Random Forests, or boosting algorithms and gradient boosting algorithms.

A second option uses generalised additive models (GAM).

A third option uses neural networks.

The second sub-module implements a correction to the estimate produced by the first sub-module. In particular, the second sub-module can implement a simple correction of a prediction bias at an initial instant, in other words a difference between the predicted imbalance and the measured imbalance at the initial instant of the prediction. The second sub-module can also implement a more complex model having been trained to predict the prediction error of the first sub-module based on the latest predicted and measured values of the axial power imbalance. The second sub-module can then, in particular, use an autoregressive model or autoregressive procedure which is a regression model for time series in which the series is explained by its past values rather than by other variables. Alternatively, the second sub-module can use a long short-term memory (LSTM) neural network which is a particular architecture of neural networks.

The utilisation of a machine learning module, and a model of the evolution of a concentration of iodine in the reactor and of a concentration of xenon in the reactor as a function of a neutron flux in the reactor enables the axial power imbalance to be reliably and rapidly estimated.

The main advantages of this method are as follows.

Firstly, the method is very easy to use: the model requires no calibration beyond the learning phase which is carried out before deployment. In other words, this step is not the responsibility of the operator who controls the reactor and more generally the user of the model.

Then, the precision obtained in the estimates of the axial imbalance is satisfactory over a time range on the order of the observed power transients, from a few hours to around a dozen hours. The application of the method to the data of the EDF nuclear fleet (Electricité de France) between 2008 and 2021, makes it possible to compare the estimates with historic measurements. The absolute error observed between the predictions of the axial imbalance DPAX made by the tool according to the present invention and the actual values of the axial imbalance DPAX are less than 2% for 95% of the data.

Finally, the method makes it possible to reduce the calculation time, in particular in comparison with the calculation time necessary for 3D calculation codes: a prediction over several hours is generated in a fraction of second by the method as opposed to several minutes for a 3D code. The rapidity of calculation of the tool enables a very large number of data to be processed, for example around 30 minutes is sufficient to evaluate predictions of the tool over 11,700 power transients. Advantageously, in operation, in order to evaluate the strategy to be followed during a transient, the processing time is of the order of a tenth of a second. Advantageously, during the course of a power transient which has been the subject of a first estimation of the evolution of the axial power imbalance, the operator can restart a second estimation process before the end of the period chosen for the first estimation. The operator can thus have a second estimate available, which makes it possible to reduce the prediction gaps.

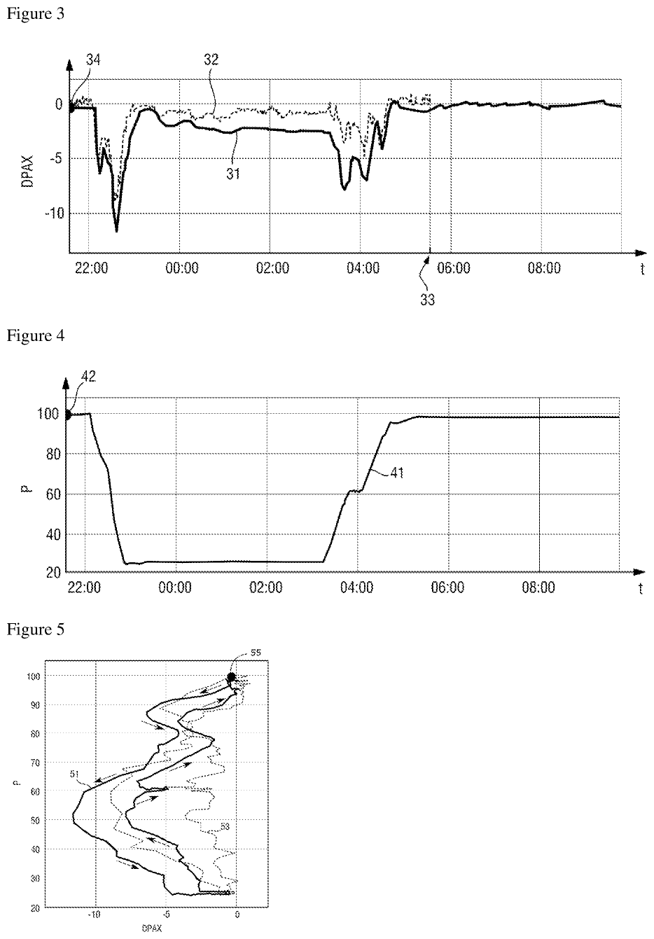

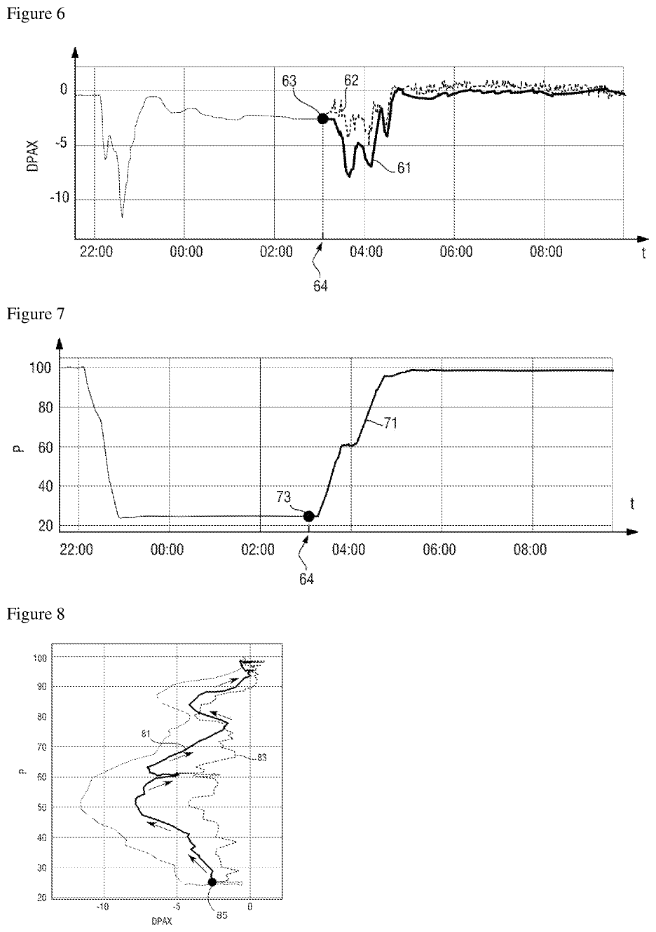

FIGS. 3, 4 and 5 on the one hand and FIGS. 6, 7 and 8 on the other hand, illustrate an application of the method.

FIGS. 3 and 6 relate to the axial imbalance DPAX as a function of time t: curves 31 and 61 represent the measured axial imbalance DPAX, while curves 32 and 62 represent the axial imbalance DPAX estimated according to the method. The time interval over which curves 31 and 61 are traced is identical to the time interval over which curves 32 and 62 are traced. This interval is graduated by time of day, the value 00:00 corresponding to midnight which separates the end of a first day on the left and the start of the following day on the right.

FIGS. 4 and 7 show the thermal power supplied by the core as a function of time t: curves 41 and 71 show the power setpoint. The time interval over which curve 41 is traced is identical to the time interval over which curve 71 is traced. This interval is graduated by time of day, the value 00:00 corresponding to midnight which separates the end of a first day on the left and the start of the following day on the right. This time interval is also identical to the time interval over which curves 31, 32, 61 and 62 are traced.

Curves 41 and 71 show a power transient with, successively over time, a reduction of the power from a high value to a low value, followed by a power plateau at the low value and finally an increase in power from the low value to the high value.

FIGS. 5 and 8 show the evolution of the measured and estimated axial imbalance DPAX, when the thermal power of the reactor follows a transient according to a programmed profile. This is a parametric relationship between two variables that are each a function of time. More precisely, the traces of FIG. 5 are the paths followed by a point (Pₜₕ(t), DPAX(t)) from a time origin 55. These paths can be deduced from FIGS. 3 and 4 with the same time origin (34, 42). The curves of FIGS. 3 and 4 are representative of functions Pₜₕ=Pₜₕ(t) and DPAX=DPAX(t); time-dependent variables.

Similarly, the traces of FIG. 8 are the paths followed by a point (Pₜₕ(t), DPAX(t)) from a time origin 85, paths that can be deduced from FIGS. 6 and 7 with the same time origin (63, 73) and the respective curves of which show the functions Pₜₕ=Pₜₕ(t) and DPAX=DPAX(t); time-dependent variables.

Trace 51 in FIG. 5 and trace 81 in FIG. 8 show the evolution of the measured axial imbalance DPAX during the evolution of the thermal power according to a transient with programmed profile. The arrows indicate the course of traces 51 and 81 in the chronological direction.

Similarly, curve 53 in FIG. 5 and trace 83 in FIG. 8 show the axial imbalance DPAX estimated according to the method of the present invention during the evolution of the thermal power according to a transient with programmed profile.

FIGS. 3, 4, 5) and (6, 7, 8) correspond to the representations in a control diagram available to operators in the control room.

The method makes it possible to estimate the future values of the axial imbalance DPAX for a number of hours that can be fixed before the method, depending on the desired time period. FIGS. 3 to 8 correspond to a time period of 8 hours. This is why, in FIG. 3, curve 32 corresponding to the estimated axial imbalance DPAX, stops at the instant 33 on leaving the transient. The estimate corresponding to curve 32 extends over 8 hours from approximately 21:30 to 05:30 the following morning.

It should be noted that the number of hours of estimation can be reduced or increased by the operator.

The progress in time is illustrated in FIG. 3 by the cursor 34, in FIG. 4 by the cursor 42, in FIG. 6 by the cursor 63 and in FIG. 7 by the cursor 73. In FIGS. 3 and 4, the cursors 34 and 42 are placed temporally in front of the transition while in FIGS. 6 and 7, cursors 63 and 73 are located in time on the power plateau at the low value and before the increase in power from the low value to the high value.

During the implementation of the method, the operator enters the power transient into the memory so as to carry out the first step of the method. The sequence of successive values of the reactor power setpoint obtained can be displayed in the form of a graph, as illustrated in FIGS. 4 and 7.

When the third step of the method is carried out, the time series of the determined axial power imbalance DPAX can also be displayed, as illustrated by curves 32 and 62. It should be noted that if a plurality of estimates are successively started, in particular during a transient, the various curves of the estimated axial power imbalance DPAX can be displayed simultaneously.

The example of FIGS. 3 to 8 corresponds to a genuine transient that was carried out in the past on one of the reactors of the French nuclear fleet.

Estimation curves 32 and 62 of the axial power imbalance DPAX can be compared with curves 31 and 61 of the axial power imbalance DPAX that was actually measured during this transient.

In this example, the hypothetical values are, in fact, the true measured values of the plurality of variables during the transient, in other words the actually measured historical data was used on site during the transient in question.

Optionally, the method can comprise a measurement step for at least one variable of the plurality of variables. The determination of the time sequence of this variable or these variables then comprises a measurement of the variable or variables. The time series then comprises past variations of the variable.

It is possible to use the following variables among the plurality of variables of the reactor.

A first variable is the position of a device configured to absorb neutrons in the reactor. More precisely, it involves the axial position of this device which can be maintained above the zone where the neutrons circulate, or even descend into this zone. The lower the device is positioned in the structure, the more neutrons it captures.

Such a device can comprise different units or groups of rods.

A first group of rods forms a power compensation group (which can be designated by the abbreviation PCG). The PCG aims to compensate the power defect, in other words the antireactivity due to the power variation. The PCG is composed of four groups of clusters which are inserted in the core respectively one after another, according to the following series of sequences: in a first sequence, the first group is inserted until it reaches a certain depth, then in a second sequence, the second group is inserted to a certain depth before, in a third sequence, the third group is inserted to a certain depth, and finally in a fourth sequence, the fourth group is inserted to a certain depth. Each sequence cannot occur until the preceding sequence is completed. Hence, the clusters have, at each instant, a relative overlap between two distinct clusters taken two by two. The PCG can comprise a group of grey clusters which are relatively poor absorbers compared to “black” clusters defined below. The grey clusters can limit the impact on the power imbalance.

Such a device can comprise a second group of rods which is a temperature control group (that can be designated by the abbreviation R group) of absorber rods. The R group is another group enabling control in combination with variations in the boron concentration.

With respect to the first variable, it is possible to determine the future variations of this in the following manner.

For the power compensation group PCG, the position of this group can be linked to the thermal power of the reactor by a relation. This relation is established during a dedicated periodic test during which the reactor power is varied in order to determine the position of the PCG enabling the power variations to be effectively compensated. A decalibration situation can be chosen by imposing that the effective position commanded by the rods of the power compensation group PCG is not exactly the position given by the relation. In particular, it is possible to control the position of the rods of the power compensation group PCG by constant decalibration.

For the temperature regulation group, or R group, the position of the rods of this R group can be chosen to be constant. In this case, the criticality in the reactor is obtained by adjusting the concentration of boron in the heat-transfer fluid.

The criticality is linked with the neutron population in the reactor. When criticality is reached, in other words when the regime is critical, the neutron population is constant over time. Reaching criticality enables the exothermic reaction to be maintained in the reactor.

It should be noted that since the first variable is controllable, the future variations determined can be freely modified by the user.

A second variable is the measured average temperature of the reactor vessel. In order to determine the future variations of this second variable, the measured average temperature of the vessel is assumed equal to the reference temperature.

A third variable is the reference average temperature of the vessel. The reference average temperature corresponds to the temperature which would prevail within the vessel taking account of the power supplied by the reactor while the measured average temperature corresponds to the actually measured the temperature of the vessel. In order to determine the future variations of this third variable, the reference average temperature is determined from a relation which is a function of the future thermal power of the reactor.

A fourth variable is a flow rate of the heat-transfer fluid circulant in the reactor. The heat-transfer fluid is the primary fluid which enables the thermalisation of the neutrons and the transmission of heat from the reactor core to the secondary circuit. In order to determine the future variations of this fourth variable, the primary flow rate can be established from the future thermal power of the reactor. More precisely, a “nominal” value from start to start of the cycle is defined during a dedicated periodic test. This “nominal” value then varies as a function of the thermal power according to a linear empirical law.

A fifth variable is a concentration of a chemical species in the heat-transfer fluid, the chemical species being configured to absorb neutrons in the reactor. For example, this chemical species is boron. The future values of the concentration of the chemical species such as boron can be determined using a second statistical model using, as input, the concentration of xenon and the position of the device configured to absorb neutrons in the reactor. This second statistical model is similar to the first model for estimating future values of the axial power imbalance, with the difference that, in the first model, the concentration of boron is an explanatory variable and that, in the second model, the concentration of boron is the explained variable or response variable.

When the future variations of the fifth variable, and in particular the concentration of boron are imposed, then it is necessary to use another adjustment variable, such as, in particular, the R group.

If the concentration of boron is not provided by the operator, the prediction model does not use boron as explanatory variable.

A sixth variable is a rate of combustion of a nuclear fuel contained in the reactor. In order to determine the future variations of this sixth variable, the future rate of combustion of the fuel is considered to be equal to the product of the thermal power times the operating time, which product is then divided by the initial mass of fuel. It is also possible to use the integral of the thermal power over the operating time, which integral is then divided by the initial mass of fuel.

In addition, the time series of the axial power imbalance can also be determined by taking into account a type of fuel management corresponding to a splitting of a core of the reactor at the time of a renewal of the fuel, an enrichment of the fissile nuclei of the reactor and a type of heavy nuclei of the reactor. The type of fuel management and the type of heavy nuclei are categorical variables and remain constant throughout a cycle. For example, the type of heavy nuclei of the reactor corresponds to the categories enriched uranium, reprocessed uranium, plutonium, etc.

The determination of the time series of the plurality of reactor variables and the determination of the time sequence of the axial power imbalance can also take into account a control scenario of the reactor corresponding to a sequence of at least one variable controllable by an operator.

A controllable variable can be the position of a device configured to absorb neutrons in the reactor or else the concentration of a chemical species in the heat-transfer fluid.

The operator can define a control scenario, in other words the various actions that it is envisaged to carry out. These relate to the controllable variables such as, for example, the positions of the control rods or the boron concentration. The operator chooses, for at least one controllable variable, a sequence of successive values which the variable takes during the next hours.

For example, the operator can rely on a first estimate of the evolution of the axial power imbalance, without a scenario being specified and on the basis of this simulation, determines a scenario and relaunches a second estimate of the evolution of the axial power imbalance which this time takes into account the determined scenario.

The method can further comprise a step of determining a score of the control scenario. This score can, for example, be a value of a quantity chosen from: a volume of effluent produced, an average difference from the reference axial imbalance and an average distance or average margin to the limits of an operating range of the reactor. Other formulas for calculating the score can be used.

The reference axial imbalance corresponds to the reference straight line in the control diagram which represents the reference axial imbalance as a function of the instantaneous total power.

The operating range of the reactor and thus the limits of this range are likewise defined with respect to the control diagram. This operating range is a safety zone which is located around the reference straight line. It can, for example, be defined by axial imbalance limit straight lines in the diagram. The average distance to the limits can be evaluated as the distance to one of these limiting axial imbalance straight lines.

The score of the scenario can provide the operator with an evaluation of the scenario estimated with respect to effluent production criteria which will require a particular treatment or reactor stability criteria.

It is possible to implement an estimate of two scenarios that the operator then compares on the basis of their respective scores. In this case:
the control scenario previously mentioned is then a first control scenario,
a second scenario is obtained and transmitted as input of the method, this second scenario corresponds to a sequence of at least one variable controllable by an operator, a different sequence to that which corresponds to the first scenario, and
the steps of the method are performed a second time by replacing the first scenario by the second scenario.

Advantageously, the method comprises a step of comparing the scores of the first scenario and the second scenario.

It should be noted that the different curves corresponding to the different estimated scenarios can be displayed on the same graph in order to be able to be visually compared by the operator.

When the method comprises a step of comparing the scores of the first scenario and the second scenario, the method can further provide a classification of the scenarios in increasing order for the selected criteria or, if several criteria have been calculated, for each of these criteria.

With reference to FIG. 2, it is the device 20 for assisting with the decision which can provide this classification of the scenarios.

For example, with respect to the criterion for the volume of effluents produced, a first scenario during which it is estimated that 20 m³ of effluent are produced is classified better than a second scenario during which it is estimated that 60 m³ of effluent are produced.

For example, with respect to the criterion for difference from the reference axial imbalance, a first scenario during which it is estimated that the difference from the reference axial imbalance is on average equal to 2% is classified better than a second scenario during which the difference from the reference axial imbalance is on average equal to 4%.

For example, with respect to the criterion of margin to the limits of the operating range and, where applicable, to the limiting axial imbalance straight lines, a first scenario during which it is estimated that the margin to the limits of the operating range is on average equal to 5% is classified better than a second scenario during which the margins to the limits of the operating range is on average equal to 3%.

The device 20 for decision assistance can also determine an overall score of the scenario which takes into account a plurality of scores. The device 20 can then provide a scenario suggestion which optimises the various criteria taken into account in the overall score.

Once the scenario is chosen by the operator and the different setpoints are actually imposed on the reactor, it is possible to perform estimates successively over time. Hence, the method can be repeated every minute so as to provide, each minute, a new estimate of the temporal evolution of the evolution of the axial imbalance DPAX. The frequency of repetition of the method can be determined in advance by the operator.

The method can also be used to list various scenarios or various “acceptable” control strategies. This consists of finding scenarios, in the sense of series of acceptable actions to be performed by the operator, in other words that enable him to respect the limits of insertion and extraction of control groups and enabling the core to remain critical (keff=1). The idea is to test various possible control solutions that are determined, for example, by disturbing one or more scenarios previously identified as acceptable. The method can also classify these various scenarios.

The method can also be used to evaluate the impact on the axial imbalance DPAX of a potential need to rapidly increase the power of the reactor.

In order to do this, additional hypothetical power transients can be determined, simulating rapid power increases of the reactor. This involves creating sequences of successive values of the power of the reactor. These sequences take, as first values, values of the sequence of power setpoints imposed on the reactor. Then, the steps of the method for estimating the axial imbalance are performed on the basis of these transients. A stability parameter can be determined based on the difference from the reference axial imbalance, the distance to the reference straight line or else on the margin to the limits of the operating range. An alert can be sent to the operator when the stability parameter crosses a threshold, in particular in the case of risk of exceeding the margin which the operator has with respect to the operating limits to be observed, or a reduced margin. The operator can then adapt the strategy as a consequence and, in particular, if it is desired to be able to satisfy a potential need for a rapid increase in power of the reactor. This estimation can be carried out at constant frequency, for example every half hour.

Finally, the method presented until now has been able to allow a potential impact of a remote adjustment on the axial imbalance DPAX to be evaluated. Here, remote adjustment means a secondary adjustment of the electrical power produced by the facility and consequently the thermal power produced by the reactor, which has the double objective of, on the one hand, restoring the primary reserve to its nominal value and, on the other hand, re-establishing predicted power values at the points of interconnection with the rest of the grid, for example the European electricity grid. A remote adjustment is sent by a manager of the electricity transport network, according to a signal which can take values between −1 and +1. This remote adjustment is sent to a set of power plants which constitute a secondary reserve so that they modulate the power that they were initially charged with producing: the value −1 of the remote adjustment signal corresponds to a reduction in power of the entire reserve power. A reserve power of a power plant corresponds to approximately 5% of the nominal power; the value +1 of the remote adjustment signal corresponds to an increase in the entire reserve power.

In order to evaluate the potential impact of a remote adjustment on a reactor, the method can estimate a power variation corresponding to a remote adjustment following steps close to those which have been described previously with respect to the evaluation of an impact on the axial imbalance DPAX of a potential need to rapidly increase the power of the reactor. The method can comprise a step of alerting the operator in case of risk of exceeding the margin which the operator has, relative to the operating limits to be observed. The operator can then adapt the strategy as a consequence.

An object of the invention is a computer program comprising instructions suitable for implementing at least one of the steps of the method, as presented above, when said program is executed on a computer.

An object of the invention is a device for estimating a future value of an axial power imbalance in a nuclear reactor, the device comprising a computing module configured to implement the method as it has been presented so far, the computing module being configured to
obtain a sequence of successive values of a reactor power setpoint,
determine, for each variable of a plurality of variables of the reactor, a sequence of successive values of the variable, the sequence representing future variations of the variable, the variations being estimated by taking into account the power setpoint, the plurality of variables of the reactor comprising a concentration of xenon in an upper half of the reactor and a concentration of xenon in a lower half of the reactor,
determine a sequence of successive values of the axial power imbalance by taking into account the sequence of the plurality of variables of the reactor,

the computing module comprising a machine learning module trained beforehand on historic reactor data, and

the computing module using a model of evolution of a concentration of iodine and of a concentration of xenon as a function of a neutron flux, so as to determine the sequence of the concentration of xenon in the upper half of the reactor and the sequence of the concentration of xenon in the lower half of the reactor.

1. Method for estimating an axial power imbalance in a nuclear reactor, the method comprising the following steps:
obtaining a sequence of successive values of a reactor power setpoint,
for each variable of a plurality of variables of the reactor, determining a sequence of successive values of the variable, the sequence representing future variations of the variable, the variations being estimated by taking into account the sequence of the power setpoint, the plurality of variables of the reactor comprising a concentration of xenon in an upper half of the reactor and a concentration of xenon in a lower half of the reactor, and
determining a sequence of successive values of the axial power imbalance, by taking into account the sequences of the plurality of variables of the reactor,
the determination of the sequence of the axial power imbalance using a machine learning module trained beforehand on historic reactor data, and
the determination of the sequence of the concentration of xenon in the upper half of the reactor and the determination of the sequence of the concentration of xenon in the lower half of the reactor using a model of the evolution of a concentration of iodine and of a concentration of xenon as a function of a neutron flux in the reactor.

2. The method according to claim 1, wherein for at least one variable of the plurality of variables, the determination of the sequence of successive values of the variable comprises a measurement of the variable.

3. The method according to claim 1, wherein the plurality of variables of the reactor comprises at least one of:
a position of a device configured to absorb neutrons in the reactor,
a measured average temperature of a reactor vessel,
a flow rate of a heat-transfer fluid circulating in the reactor,
a concentration of a chemical species in the heat-transfer fluid, the chemical species being configured to absorb neutrons in the reactor, and
a rate of combustion of a nuclear fuel contained in the reactor.

4. The method according to claim 3, wherein the determination of the sequence of the axial power imbalance also takes into account at least one of: a reference average temperature of the vessel, a type of fuel management corresponding to a splitting of a reactor core during a renewal of the fuel, an enrichment of fissile nuclei of the reactor and a type of heavy nuclei of the reactor.

5. The method according to claim 1, wherein the determination of the sequence of the plurality of variables and the determination of the sequence of the axial power imbalance takes into account a control scenario of the reactor corresponding to a sequence of successive values of at least one variable controllable by an operator.

6. The method according to claim 5, further comprising a step of determining a score of the control scenario, the score preferably being a value of a quantity chosen from:
a volume of effluent produced,
an average difference between successive values of the axial power imbalance and a reference axial imbalance, and
an average distance to the limits of an operating range of the reactor.

7. The method according to claim 5, wherein the control scenario is a first control scenario, the method steps being carried out a second time by replacing the first scenario by a second control scenario of the reactor corresponding to another sequence of successive values of at least one controllable variable, the method preferably comprising a step of comparing the scores of the first scenario and a score of the second scenario.

8. A computer program comprising instructions suitable for implementing at least one of the steps of the method according to claim 1 when said program is executed on a computer.

9. A device for estimating a future value of an axial power imbalance in a nuclear reactor, the device comprising a computing module configured to implement the method according to claim 1, the computing module being configured to:
obtain a sequence of successive values of a reactor power setpoint,
determine, for each variable of a plurality of variables of the reactor, a sequence of successive values of the variable, the sequence representing future variations of the variable, the variations being estimated by taking into account the sequence of the power setpoint, the plurality of variables of the reactor comprising a concentration of xenon in an upper half of the reactor and a concentration of xenon in a lower half of the reactor, and
determine a sequence of successive values of the axial power imbalance by taking into account the sequence of the plurality of variables of the reactor,
the calculating module comprising a machine learning module trained beforehand on historic reactor data, and
the computing module using a model of evolution of a concentration of iodine and of a concentration of xenon as a function of a neutron flux in the reactor, so as to determine the sequence of the concentration of xenon in the upper half of the reactor and the sequence of the concentration of xenon in the lower half of the reactor.
